(19) United States
(12) Patent Application Publication
(10) Pub. No.: US 2008/0310820 A1
(43) Pub. Date: Dec. 18, 2008

(54) OPTIMIZING DIGITAL VIDEO RECORDER STORAGE SPACE BY COMMERCIAL SKIP MANAGEMENT

(75) Inventors: Kevin M. Corry, Pflugerville, TX (US); Mark A. Peloquin, Austin, TX (US); Steven Pratt, Leander, TX (US); Karl M. Rister, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/762,997

(22) Filed: Jun. 14, 2007

(51) Int. Cl. H04N 5/91

(52) U.S. Cl. 386/95

(57) ABSTRACT

A method for storing a program for subsequent playback, includes: receiving an input signal including the program; parsing the input signal to provide at least one segment of commercial content and at least one segment of program content; indexing a segment list with segment information related to each segment; and storing each segment and the segment list for input to a playback device. A method for playback and a computer program product are provided.

### BACKGROUND OF THE INVENTION

1. Field of the Invention

This invention relates to video playback devices, and in particular, to optimizing use of DVR storage space.

2. Description of the Related Art

Digital Video Recorders (DVR) have provided users (i.e., viewers) with considerable flexibility when viewing television (TV) programming. For example, users may record a show while away from their TV set, and may return to watch the show at their leisure.

It is commonly known that most consumers don't want to watch television (TV) commercials and would rather just see their desired show. Consider that the length of a typical TV program includes over twenty five percent of program time for commercials (i.e., a one hour program usually has about forty four minutes of programming, with the remaining time for commercials). However, storing commercial content on a DVR increases the amount of recorder storage space needed by each program recording and reduces the number of recordings that can be stored simultaneously.

What is needed is a technique for making efficient use of storage space on a digital video recording (DVR) device.

### SUMMARY OF THE INVENTION

The shortcomings of the prior art are overcome and additional advantages are provided through the provision of a pause soon feature disclosed herein.

Disclosed is a method for storing a program for subsequent playback, the method including: receiving an input signal including the program; parsing the input signal to provide at least one segment of commercial content and at least one segment of program content; indexing a segment list with segment information related to each segment; and storing each segment and the segment list for input to a playback device.

Also disclosed is a method for playing a stored program, the method including: receiving a program selection for playback; determining playback information from at least one of program content and commercial content associated with the program selection; retrieving the associated content; and playing the associated content.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides a digital video recorder (DVR) that makes efficient use of storage resources. For example, provided herein is a computer program product stored on machine readable media and including machine executable instructions for storing and playing a program, the product including instructions for: storing the program by receiving an input signal including the program; parsing the input signal to provide at least one segment of commercial content and at least one segment of program content; indexing a segment list with segment information related to each segment; storing each segment and the segment list for input to a playback device; and playing the program by receiving a program selection for playback; determining playback information from at least one of program content and commercial content associated with the program selection; retrieving the associated content; playing the associated content.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a video playback device;

FIG. 2 is an exemplary flow chart for storing a program; and

FIG. 3 is an exemplary flow chart for playing the stored program.

The detailed description explains the preferred embodiments of the invention, together with advantages and features, by way of example with reference to the drawings.

### DETAILED DESCRIPTION OF THE INVENTION

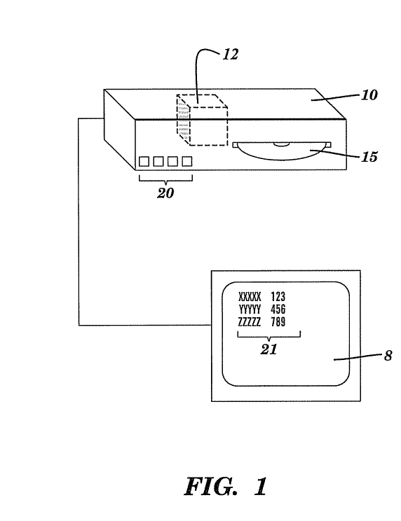

Referring to FIG. 1, a video playback device 10 is shown. The video playback device 10, also referred to herein as a “player 10” may play digital versatile disc (DVD), video-cassettes (VHS, betamax, etc, . . . ) or any other type of media 15. The video playback device 10 may include an internal storage 12 (such as a hard drive) for at least one of storing video from an input and maintaining software (i.e., machine readable instructions stored on machine readable media).

The player 10 includes various controls 20 for regulating playback of the media 15. The controls may be at least one of local (as depicted) and remote (not shown). Typically, the player 10 is coupled to and provides a signal to a display 8. In some embodiments, the display 8 provided includes an interactive on-screen menu 21 for control of the player 10.

The player 10 may include components such as a processor, various interfaces (such as a network interface, a signal input, a signal output), software and other components as are known in the art. The player 10 makes use of the various components for controlling and playback of media. As an example, the player 10 may be configured for detecting commercial breaks in recorded shows and marking jump points into a database so that such breaks can be slipped (or later cut out of the recording).

The player 10 may use a variety of different methods to detect commercial breaks. As non-limiting examples, one method, “Blank Frame Detection,” is used to determine when a program fades to black (i.e., a break in video data has occurred). Another method, “Scene Change Detection,” determines if a large amount of the picture (i.e., video data) has changed. “Blank Frame & Scene Change Detection,” employs both techniques. A further method, “Logo Detection,” looks for a part of the picture that does not change during a recorded show (e.g., an onscreen logo). As a logo is usually removed for the duration of commercial breaks, this provides an indication of the commercial break. The player 10 may use these methods as well as other detection methods alone or in various combinations.

However, since commercial detection algorithms are not perfect, the player 10 according to the teachings herein, stores rejected content (i.e., improperly omitted program content as well as commercial content) for subsequent viewing. A user is then presented with various options when viewing stored content.

When a viewer initiates a viewing session, various options may be presented for selection. For example, the viewer may elect to include the rejected content as a part of a viewing experience. Alternatively, the viewer may elect to watch only designated program content. In some embodiments, the viewer is able to discriminate content based upon detection methods used by the player 10. Accordingly, one skilled in the art will recognize that a variety of control and playback options may be made available to the viewer.

Advantageously, as commercial content can represent such a large segment of all content stored, the player 10 includes various algorithms for sorting and prioritizing deletion of commercial content. For example, when storage in the player 10 becomes full, the space consumed by oldest or lowest priority commercial content can be automatically reused for a new recording. This permits a substantial amount of storage consumed by commercial content to be automatically reused, effectively eliminating the wasted space of commercials, but also providing users with an ability to view and recover misidentified program content.

In some embodiments, the capabilities of the player 10 are implemented through software stored in the storage 12. The software is generally implemented as a recording portion and a playback portion. In an exemplary embodiment of the software, machine executable instructions are provided for implementing both portions.

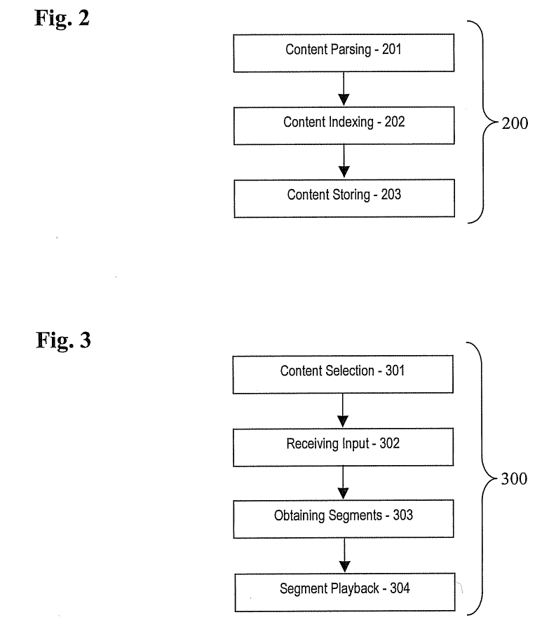

An exemplary method for recording 200 is shown in FIG. 2. In a first recording step 201, “content parsing” occurs. More specifically, instead of storing one long stream of content for each recording, containing both program content and commercial contents, content parsing calls for breaking up an input signal as program content and commercial content, where each segment of the content is assigned a separate file. At each transition between content types in the input signal, the currently recording segment is closed and another segment is opened for input. Ongoing with content parsing, a second recording step 202, referred to as “indexing” occurs. During indexing, the player 10 generates a segment list of all recorded segments. Information as may be useful to a viewer may be included in the segment list. Exemplary information for incorporation into the segment list includes segment duration, segment sequence, storage location, a segment value, date and time of file creation and other such information. Indexing may include storing some or all of the list information in each segment file. For example, each segment file may include the same information regarding the file as is maintained in the segment list. In a third recording step 203, storing of each segment occurs. That is, the input signal, now broken into segments of program content and commercial content, is stored in separate files. Storing of each segment calls for finding available space in the storage 12. In some instances, finding available space calls for overwriting low value files. In these instances, identification of low value files may be performed by referencing the segment list.

Determination of a segment value may occur in a variety of ways. For example, the software may consider older commercial content files to have lower value than more recent commercial content. In most embodiments, recent commercial content segments have a lower value than program content segments. Commercial content (and program content, for that matter) may be valued according to a variety of aspects, including, without limitation, age, source, relation to other content, time of day recorded, similarity to other content as well as others.

Referring to FIG. 3, there is shown a flow chart depicting the exemplary method for playback 300. In a first playback step 301, the user selects a program for viewing. In a second playback step 302, the software receives input regarding whether the viewer wishes to playback only program content, or program content with the rejected content. In a third playback step 303, the software refers to the segment list and obtains the segments that correlate to the selected program. In a fourth playback step 304, the software plays back available segments for the selected program. The software may skip overwritten segments altogether, may notify the user of omitted segments or otherwise address missing segments in the playback.

Accordingly, a variety of additional features may be included to complement the teachings herein. For example, the player 10 may include ancillary software for at least one of ranking, prioritizing, labeling and classifying rejected content. The software may be provided as an “add-in.” That is, the software may be provided as a compliment to other software for operation of a prior art player.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for storing a program for subsequent playback, the method comprising:
receiving an input signal comprising the program;
parsing the input signal to provide at least one segment of commercial content and at least one segment of program content;
indexing a segment list with segment information related to each segment; and
storing each segment and the segment list for input to a playback device.

2. The method of claim 1, wherein parsing the input signal comprises detecting a break by at least one of blank frame detection, scene change detection and logo detection.

3. The method of claim 1, wherein indexing comprises assigning a value to each segment.

4. The method of claim 3, wherein assigning the value comprises assessing at least one of an age, source, relation to other content, time of day recorded, similarity to other content.

5. The method of claim 3, further comprising revising a file value for a selected segment.

6. The method of claim 1, wherein storing comprises overwriting low value files.

7. A method for playing a stored program, the method comprising:
receiving a program selection for playback;
determining playback information from at least one of program content and commercial content associated with the program selection;
retrieving the associated content; and
playing the associated content.

8. The method of claim 7, further comprising: modifying a determination for the playback information.

9. The method of claim 7, further comprising at least one of skipping and including selected commercial content.

10. The method of claim 7, further comprising revising a file value for at least one of the program content and the commercial content.

11. A computer program product stored on machine readable media and comprising machine executable instructions for storing and playing a program, the product comprising instructions for:
storing the program by receiving an input signal comprising the program;
parsing the input signal to provide at least one segment of commercial content and at least one segment of program content;
indexing a segment list with segment information related to each segment;
storing each segment and the segment list for input to a playback device; and
playing the program by receiving a program selection for playback;
determining playback information from at least one of program content and commercial content associated with the program selection;
retrieving the associated content;
playing the associated content.
